(19) United States
(12) Patent Application Publication
(10) Pub. No.: US 2004/0253337 A1
(43) Pub. Date: Dec. 16, 2004

(54) Method and mold assembly for producing a plastic molded object

(76) Inventors: Masaomi Hashimoto, Atsugi-shi (JP); Motoyasu Murai, Atsugi-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/671,590

(22) Filed: Sep. 29, 2003

(30) Foreign Application Priority Data
Sep. 27, 2002 (JP) 2002-284526

(51) Int. Cl. B29C 43/04

(52) U.S. Cl. 425/354; 425/411

(57) ABSTRACT

A method of producing a plastic molded object, including preparing a mold assembly including a cavity that forms a surface of the plastic molded object with a transfer surface of the cavity, a slide cavity piece including a sliding surface and a molding surface forming at least a part of one surface of the plastic molded object, and a metallic mold that slidably holds the slide cavity piece, heating the mold assembly to a temperature lower than a softening temperature of a molten resin, filling the cavity with the molten resin, cooling the molten resin to a temperature lower than the softening temperature of the molten resin, wherein the cooling includes contracting a volume of the molten resin, and sliding the slide cavity piece toward the molten resin by a contact-force of the molding surface with the molten resin, thereby compensating for contraction of the volume of the molten resin.

### CROSS-REFERENCE TO RELATED APPLICATIONS

The present application claims priority to Japanese Patent Application No. 2002-284526 filed in the Japanese Patent Office on Sep. 27, 2002, the disclosure of which is incorporated herein by reference.

### BACKGROUND OF THE INVENTION

### FIELD OF THE INVENTION

The present invention relates to a method and mold assembly for producing a plastic molded object such as a plastic lens, and a plastic mirror, for use, for example, in an optical scanning system of a digital laser copying machine, a laser printer, and a laser facsimile machine, and in an optical instrument such as a video camera.

### DISCUSSION OF THE BACKGROUND

Optical elements, such as a lens, and a mirror, having laser beam imaging and correcting functions, have been used in a laser writing unit for use in a digital laser copying machine, a laser printer, a laser facsimile machine, and other similar image forming apparatus.

Recently, with increasing demands for reducing costs of products, such an optical element is changed to be formed from a plastic rather than a glass. Further, to perform a plurality of functions with a minimum optical element, a mirror surface of the optical element is formed into a complicated non-spherical shape as well as a spherical shape. When using a lens as an optical element, the thickness of the lens is often designed to be large, and to be uneven in its longitudinal direction.

Such a plastic molded object, even if it has a special shape, can be mass-produced at a low cost by filling a cavity of a mold assembly with a molten resin by an injection molding method. The shape of a cavity equals the shape of a molded object. Specifically, a molded object, for example, has at least one mirror surface as an optical surface, as well as non-optical surfaces. When a molten resin filled in a cavity is cooled and pressed against a transfer surface of a cavity piece forming the cavity, the transfer surface engages the resin, and thereby a mirror surface as an optical surface of a molded object is formed.

In the above-described background of plastic molding, during the step of cooling a resin filled in a cavity to solidify the resin, the pressure and temperature of the resin in the cavity need to be uniform to form a plastic molded object into a desired shape with accuracy.

For example, when a lens has an uneven thickness, the cooling speed of a resin varies between several portions of the lens due to its different (uneven) thickness, resulting in differences in the amount of volume contraction of the resin. As a result, the accuracy of the shape of the lens deteriorates, and a sink is formed at a thick portion of the lens.

To address the above-described problem, a molten resin is injected into a cavity of a mold assembly with a larger pressure, and thereby the amount of the resin filled in the cavity increases. However, in this condition, internal distortions of the plastic molded object increase. Especially, if the plastic molded object has uneven thick portions (i.e., thick and thin portions), internal distortions increase in its thin portion, thereby causing the optical performance of the plastic molded object to deteriorate.

Specifically, when a molten resin is injected into a cavity of a mold assembly with low pressure and the amount of the resin filled in the cavity decreases to reduce an internal distortion of a plastic molded object, a sink may be formed at a thick portion of the plastic molded object. On the other hand, when a molten resin is injected into a cavity of a mold assembly with large pressure and the amount of the resin filled in the cavity increases, an internal distortion may increase in a thin portion of the plastic molded object,

As a background injection molding technique, for example, published Japanese patent application No. 63-114614 describes an injection mold assembly in which a shape accuracy of a molded object is obtained by performing a so-called injection and compression molding method. Specifically, an insertion piece forming one wall surface of a cavity is configured to slide by a compressing mechanism provided in a mold assembly. When a molten resin filled in the cavity is cooled and contracts, the insertion piece slides to press the resin by the compressing mechanism and brings even pressure to the resin. Thus, the contraction of the resin caused by cooling and solidifying the resin can be compensated by the compressing mechanism.

Another background injection molding technique is described, for example, in published Japanese patent application No. 11-28745, in which a plastic molded object is produced with high accuracy even if the plastic molded object has a thick portion or an uneven thick portion. In published Japanese patent application No. 11-28745, a slide cavity piece (i.e., a molding piece for forming a cavity) is provided to form a side surface of a cavity other than a transfer surface. When a molten resin filled in a cavity is cooled to a temperature lower than a softening temperature of the resin, a gap is forcibly formed between the resin and the slide cavity piece. This is done by sliding the slide cavity piece in a direction away from the resin. Because the contact-force of the resin with a wall surface of a cavity piece that forms the cavity of a mold assembly is not exerted on a portion of the resin facing the gap, the resin easily moves. Therefore, a concave or convex or concave/convex shaped sink is formed only at the portion of the resin facing the gap. As a result, a sink is prevented from occurring at a transfer surface of a molded object, and thereby a highly accurate molded object is obtained. Further, a good quality molded object is obtained by molding at a low pressure while reducing an internal distortion of the molded object.

An example of a background injection molding method will be described referring to FIG. 1. As illustrated in FIG. 1, a mold assembly 10a for producing a molded object such as a plastic optical element (not shown), includes a lower cavity piece 11 that has a transfer surface 11a for transferring a mirror surface onto a molten resin 13 (i.e., one mirror surface of the molded object is formed with the transfer surface 11a), and an upper cavity piece 14 that has a transfer surface 14a for transferring a mirror surface onto the molten resin 13 (i.e., another mirror surface of the molded object is formed with the transfer surface 14a). The mold assembly 10a further includes a slide cavity piece 12 and a side cavity piece 15. A cavity (A) is formed by the transfer surfaces 11a and 14a, a side surface (i.e., a non-transfer surface) of the slide cavity piece 12, and a side surface (i.e., a non-transfer surface) of the side cavity piece 15.

The molten resin 13 is loaded into the cavity (A) and is then cooled. During the period that the molten resin 13 in the cavity (A) is cooled to a temperature lower than a softening temperature of the resin, the slide cavity piece 12 is slid in a direction away from the resin 13, and thereby a gap 17 is formed between the resin 13 and the slide cavity piece 12. When the molten resin 13 in the cavity (A) is cooled, a sink is formed only at a portion of the resin 13 facing the gap 17. This is because the contact-force of the resin 13 with a wall surface of the cavity piece of the mold assembly 10a is not exerted on the portion of the resin 13 facing the gap 17. After the molten resin 13 has cooled until the temperature distribution of the resin in the cavity (A) becomes equal to the temperature of the mold assembly 10a, a molded object (not shown) is taken out of the mold assembly 10a.

In the mold assembly 10a of FIG. 1, the thermal conductivity of the gap 17 is lower than that of the metal material of the cavity pieces forming the cavity (A), and thereby a high temperature portion 18 and a low temperature portion 19 asymmetrically exist in the resin 13 as illustrated in FIG. 1.

FIG. 2 is a schematic view of a background mold assembly for producing a long molded object, and FIG. 3 is a schematic view of the long molded object produced by the background mold assembly of FIG. 2. A mold assembly 10b includes a long slide cavity piece 22 as illustrated in FIG. 2. The method of producing a long molded object 43 by the mold assembly 10b is similar to that of the mold assembly 10a, therefore its description is omitted here.

As in the case of the mold assembly 10a, the high temperature portion 18 and the low temperature portion 19 asymmetrically exist in the resin 13 as illustrated in FIG. 2. When the long molded object 43 is taken out of the mold assembly 10b in the condition in which the temperature distribution of the resin 13 is uneven, the long molded object 43 deforms due to differences in contraction rates caused by the temperature difference between its side portions as illustrated in FIG. 3. As a result, a molded object cannot be produced with high accuracy.

### SUMMARY OF THE INVENTION

According to one aspect of the present invention, a method of producing a plastic molded object includes preparing a mold assembly including a cavity that forms at least one surface of the plastic molded object with at least one transfer surface of the cavity, at least one slide cavity piece including at least one sliding surface, and at least one molding surface that forms at least a part of at least one surface of the plastic molded object, and at least one metallic mold that slidably holds the at least one slide cavity piece, heating the mold assembly to a temperature lower than the softening temperature of a molten resin, filling the cavity with the molten resin heated to at least the softening temperature of the molten resin by injecting the molten resin in the cavity, generating a pressure on the at least one transfer surface of the cavity, thereby bringing the molten resin into intimate contact with the at least one transfer surface of the cavity, cooling the molten resin to a temperature lower than the softening temperature of the molten resin, and taking the plastic molded object from the mold assembly. The cooling includes contracting a volume of the molten resin, and sliding the at least one slide cavity piece toward the molten resin in the cavity by a contact-force of the at least one molding surface of the at least one slide cavity piece with the molten resin, thereby compensating for contraction of the volume of the molten resin.

According to another aspect of the present invention, a mold assembly for producing a plastic molded object out of a resin, includes a cavity configured to be filled with a molten resin heated to a temperature equal to at least a softening temperature of the resin and to form at least one surface of the plastic molded object with at least one transfer surface of the cavity, at least one slide cavity piece including at least one sliding surface, and at least one molding surface that forms at least a part of at least one surface of the plastic molded object, and at least one metallic mold configured to slidably hold the at least one slide cavity piece. During the period when the molten resin in the cavity cools to a temperature lower than a softening temperature of the resin, the volume of the molten resin in the cavity contracts and the at least one slide cavity piece slides toward the molten resin in the cavity by a contact-force of the at least one molding surface of the at least one slide cavity piece with the molten resin to compensate for contraction of the volume of the molten resin.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic view of a background mold assembly;

FIG. 2 is a schematic view of another background mold assembly for producing a long molded object;

FIG. 3 is a schematic view of the long molded object produced by the background mold assembly of FIG. 2;

FIG. 4 is a schematic sectional view of a mold assembly according to an embodiment of the present invention when a resin is loaded into a cavity of the mold assembly;

FIG. 5 is a schematic sectional view of the mold assembly of the embodiment of the present invention when a slide cavity piece slides toward the resin in the cavity of the mold assembly;

FIG. 6 is a schematic sectional view of the mold assembly of the embodiment of the present invention when the resin in the cavity of the mold assembly is cooled and solidified;

FIG. 7 is a schematic sectional view of a mold assembly according to another embodiment of the present invention;

FIG. 8 is a schematic sectional view of a mold assembly according to another embodiment of the present invention;

FIG. 9 is a schematic sectional view of a mold assembly according to another embodiment of the present invention;

FIG. 10 is a schematic view of a plastic molded object produced with the mold assembly that has a thick portion and transition portions;

FIG. 11 is a schematic sectional view of a mold assembly according to another embodiment of the present invention; and

FIG. 12 is a schematic view of an optical plastic lens as an example of a plastic molded object.

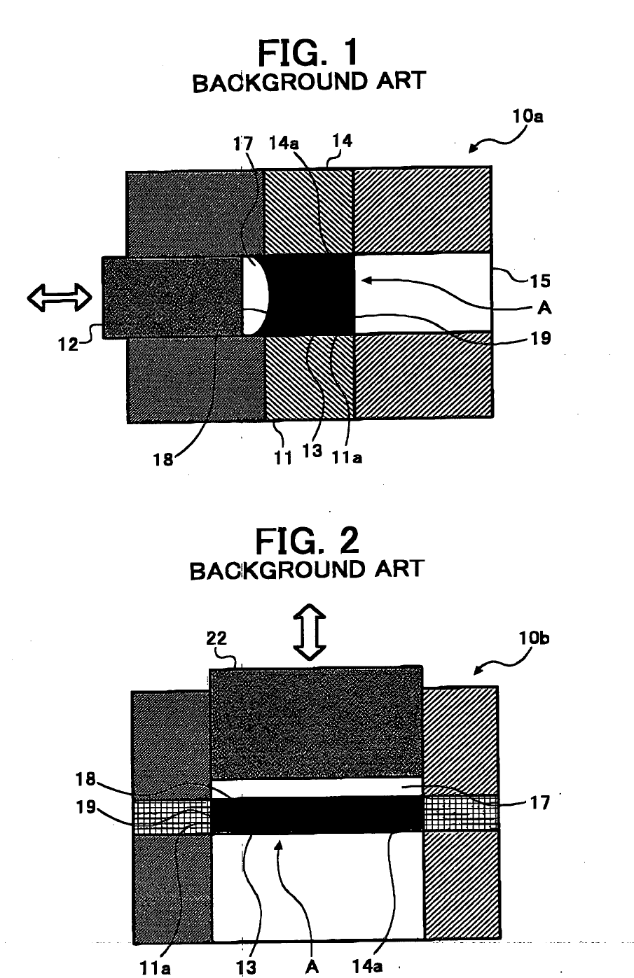

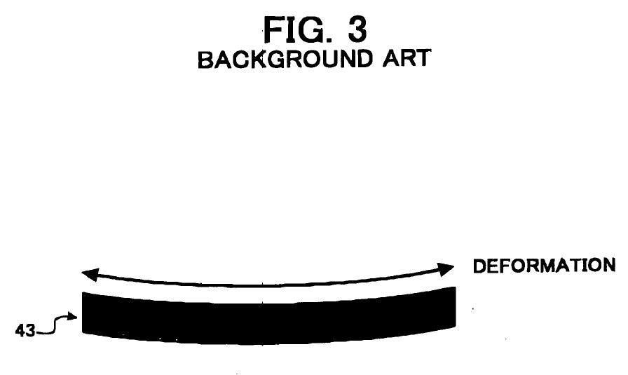

### DETAILED DESCRIPTION OF THE PREFERRED EMBODIMENTS

Preferred embodiments of the present invention are described in detail referring to the drawings, wherein like reference numerals designate identical or corresponding parts throughout the several views.

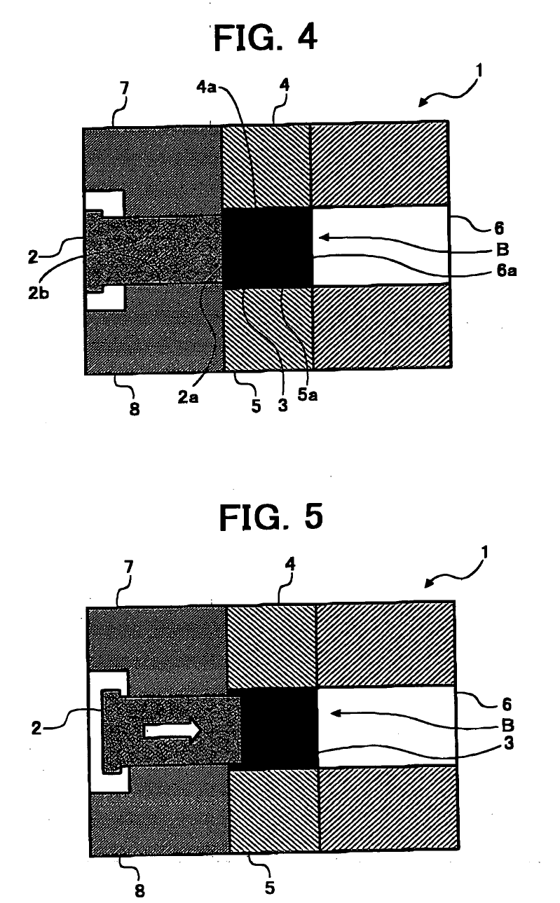

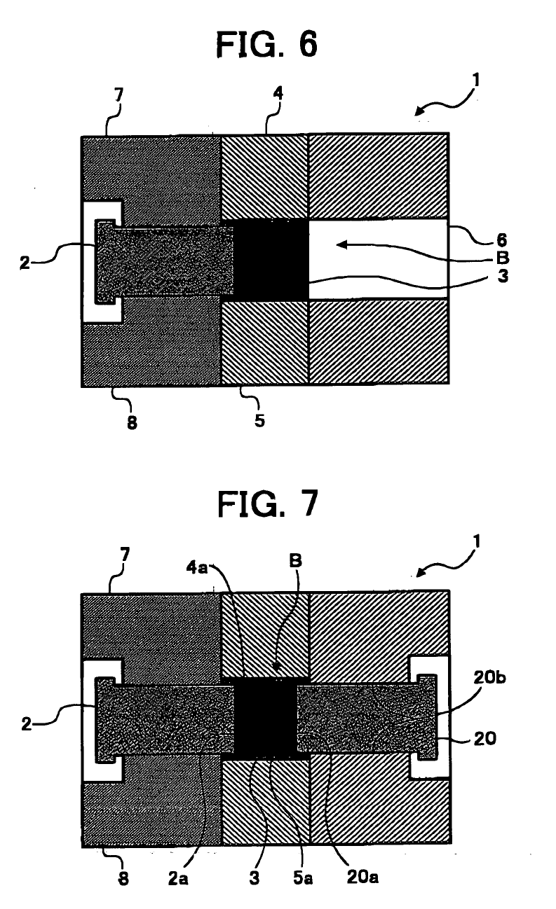

FIG. 4 is a schematic sectional view of a mold assembly according to an embodiment of the present invention when a resin is loaded into a cavity of the mold assembly. FIG. 5 is a schematic sectional view of the mold assembly of the embodiment of the present invention when a slide cavity piece slides toward the resin in the cavity of the mold assembly. FIG. 6 is a schematic sectional view of the mold assembly of the embodiment of the present invention when the resin in the cavity of the mold assembly is cooled and solidified.

Referring to FIGS. 4 through 6, a mold assembly 1 for producing a plastic molded object (not shown), includes an upper cavity piece 4 that has a transfer surface 4a for transferring a mirror surface onto a molten resin 3 (i.e., one mirror surface of the plastic molded object is formed with the transfer surface 4a), and a lower cavity piece 5 that has a transfer surface 5a for transferring a mirror surface onto the molten resin 3 (i.e., another mirror surface of the plastic molded object is formed with the transfer surface 5a). The mold assembly 1 further includes a slide cavity piece 2, a side cavity piece 6, and metallic molds 7 and 8 that slidably hold the slide cavity piece 2. A cavity (B) is formed by the transfer surface 4a of the upper cavity piece 4, the transfer surface 5a of the lower cavity piece 5, a molding surface 2a of the slide cavity piece 2, and a side surface 6a of the side cavity piece 6. In other words, the mold assembly 1 is prepared, which includes the cavity (B) that forms at least one surface of a plastic molded object with at least one transfer surface of the cavity (B), at least one slide cavity piece including at least one molding surface that forms at least a part of at least one surface of a plastic molded object, and at least one metallic mold that slidably holds the at least one slide cavity piece.

Next, a production of a plastic molded object with the mold assembly 1 will be described. First, the mold assembly 1 is heated to a temperature lower than a softening temperature of the molten resin 3. Subsequently, as illustrated in FIG. 4, the molten resin 3 heated to at least the softening temperature of the molten resin 3 is injected into the cavity (B) of the mold assembly 1. A pressure is generated on the transfer surfaces 4a and 5a, and thereby the molten resin 3 is brought into intimate contact with the transfer surfaces 4a and 5a. Subsequently, the molten resin 3 filled in the cavity (B) is cooled to a temperature lower than the softening temperature of the molten resin 3. In this cooling process, a contact-force is exerted between the molding surface 2a of the slide cavity piece 2 and the molten resin 3 in the cavity (B), and the slide cavity piece 2 slides toward the molten resin 3 in the direction indicated by an arrow in FIG. 5, as the volume of the molten resin 3 in the cavity (B) contracts while the molten resin 3 is cooled. Then, referring to FIG. 6, the molten resin 3 is uniformly cooled until the temperature of the entire molten resin 3 (i.e., a plastic molded object) becomes substantially equal to the temperature of the mold assembly 1. Finally, a plastic molded object made of the resin 3 is taken out of the mold assembly 1.

In this method of producing a plastic molded object, the contraction of the volume of the molten resin 3 caused by cooling the resin 3 is compensated by the sliding movement of the slide cavity piece 2. As a result, the occurrence of a sink in the plastic molded object can be prevented. Further, because the slide cavity piece 2 constantly contacts the molten resin 3, the plastic molded object made of the molten resin 3 can be uniformly cooled without causing uneven temperature distribution of the plastic molded object. As a result, the plastic molded object can be produced with high accuracy without being deformed.

FIG. 7 is a schematic sectional view of a mold assembly according to another embodiment of the present invention. In this embodiment, as illustrated in FIG. 7, the mold assembly 1 includes a slide cavity piece 20 that has a molding surface 20a, in place of the side cavity piece 6 in FIG. 4. In the mold assembly 1 of the present embodiment, each of the molding surface 2a of the slide cavity piece 2 and the molding surface 20a of the slide cavity piece 20 forms at least a part of a surface of the plastic molded object other than surfaces of the plastic molded object formed with the transfer surfaces 4a and 5a.

With the slide cavity pieces 2 and 20, the contraction of the molten resin 3 caused by cooling the resin 3 is further compensated by the sliding movements of the slide cavity pieces 2 and 20. As a result, the occurrence of a sink in the plastic molded object can be prevented.

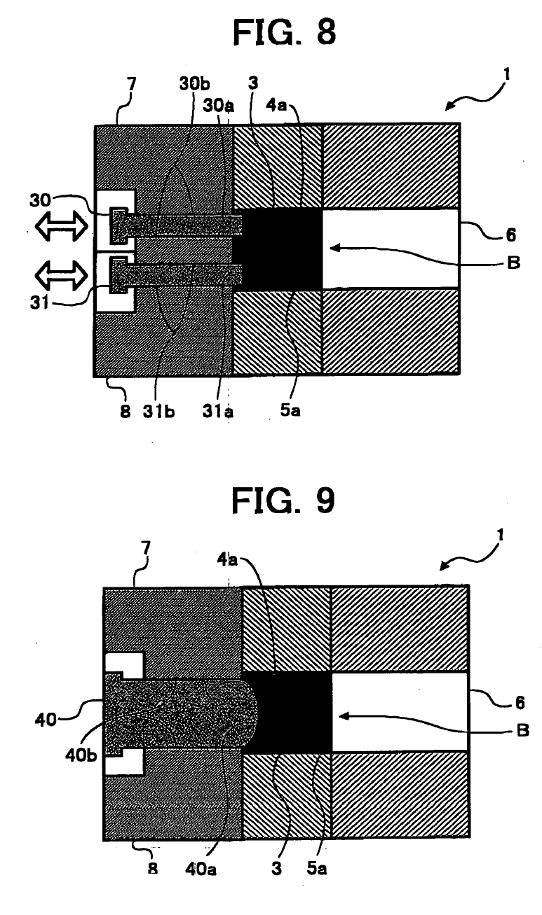

FIG. 8 is a schematic sectional view of a mold assembly according to another embodiment of the present invention. In this embodiment, as illustrated in FIG. 8, the mold assembly 1 includes two slide cavity pieces 30 and 31 that have molding surfaces 30a and 31a, respectively, on one side surface of the cavity (B). In the mold assembly 1 of the present embodiment, the molding surfaces 30a and 31a of the slide cavity pieces 30 and 31 form at least a part of one side surface of the plastic molded object other than surfaces of the plastic molded object formed with the transfer surfaces 4a and 5a. With the slide cavity pieces 30 and 31, the contraction of the molten resin 3 caused by cooling the resin 3 is further compensated by the sliding movements of the slide cavity pieces 30 and 31. As a result, the occurrence of a sink in the plastic molded object can be prevented.

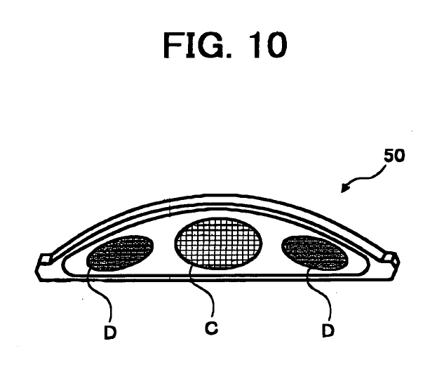

FIG. 9 is a schematic sectional view of a mold assembly according to another embodiment of the present invention. In this embodiment, as illustrated in FIG. 9, the mold assembly 1 includes a slide cavity piece 40 that has a convex-shaped molding surface 40a protruding outward toward the cavity (B). FIG. 10 is a schematic view of a plastic molded object produced with the mold assembly 1. In FIG. 10, an area (C) of a plastic molded object 50 indicates its thick portion, and each of two areas (D) of the plastic molded object 50 indicates its transition portion from the thick portion to a thin portion.

When a sink tends to occur in the area (C) of the plastic molded object 50, for example, the slide cavity piece 40 of FIG. 9 having the convex-shaped molding surface 40a is used to slide toward the molten resin 3 in the cavity (B) to compensate for contraction of the volume of the molten resin 3 in the area (C). As a result, the occurrence of a sink in the area (C) of the plastic molded object 50 can be prevented, and thereby a highly accurate plastic molded object without a sink can be produced.

On the other hand, when a sink tends to occur in the areas (D) of the plastic molded object 50, for example, the slide cavity pieces 30 and 31 of FIG. 8 having the molding surfaces 30a and 31a are used to slide toward the molten resin 3 in the cavity (B) to compensate for contraction of the volume of the molten resin 3 in the areas (D). In this case, the occurrence of a sink in the areas (D) of the plastic molded object 50 can be prevented, and thereby a highly accurate plastic molded object without a sink can be produced. When a sink tends to occur in the substantially overall area of the plastic molded object 50, for example, the slide cavity piece 2 may be used to slide toward the molten resin 3 in the cavity (B). In the mold assembly 1 according to the embodiments of the present invention, the slide cavity pieces 2, 30/31, and 40 having different-shaped molding surfaces can be replaced with each other according to an area of the plastic molded object where a sink tends to occur.

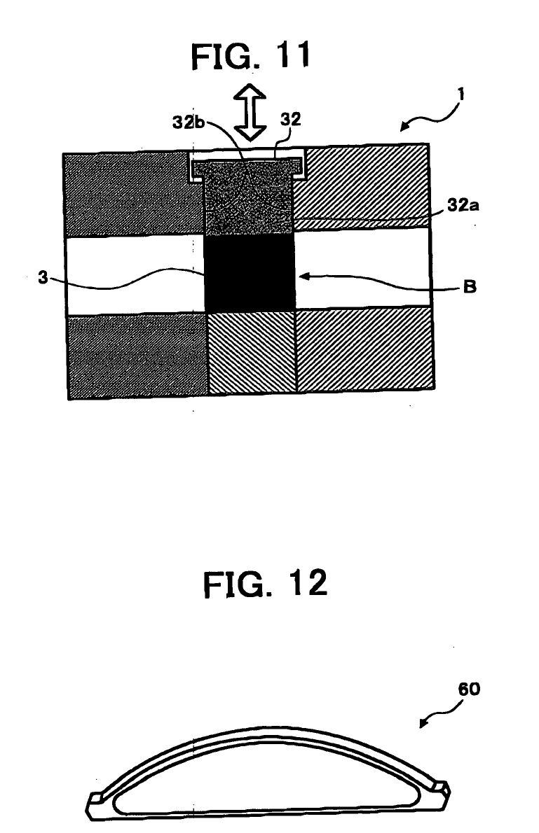

FIG. 11 is a schematic sectional view of a mold assembly according to another embodiment of the present invention. As illustrated in FIG. 11, the mold assembly 1 includes a slide cavity piece 32 that has a transfer surface 32a in place of the slide cavity piece 2 and the upper cavity piece 4 of FIG. 4. With the slide cavity piece 32, the occurrence of a sink at the transfer surface 32a, i.e., an optical surface of a plastic molded object can be prevented.

When the molding surface (2a, 20a, 30a, 31a, and 40a) of the slide cavity piece (2, 20, 30, 31, and 40) forms at least a part of one side surface (i.e., non-optical surface) of the plastic molded object that functions as a standard surface of the plastic molded object for installing the plastic molded object to another part, the occurrence of a sink at the standard surface of the plastic molded object can be prevented.

By producing a plastic molded object with the above-described mold assembly 1, the volume contraction of the molten resin 3 caused by cooling the molten resin 3 is compensated by the sliding movements of the above-described slide cavity pieces 2, 20, 30, 31, 32, and 40. As a result, the occurrence of a sink in a plastic molded object can be prevented. Further, in this method of producing the plastic molded object, because the slide cavity pieces 2, 20, 30, 31, 32, and 40 constantly contact the molten resin 3, the plastic molded object made of the molten resin 3 can be uniformly cooled without causing uneven temperature distribution of the plastic molded object. As a result, the plastic molded object can be produced with high accuracy without being deformed, Moreover, in this method of producing the plastic molded object, because the sliding movements of the slide cavity pieces 2, 20, 30, 31, 32, and 40 are performed by the contact-force of their molding surfaces with the molten resin 3. Thus, the slide cavity pieces 2, 20, 30, 31, 32, and 40 can slide without using a drive device, such as a hydraulic cylinder, and an electric motor. Therefore, a plastic molded object free from a sink can be easily produced with high accuracy and at a low cost.

The contact-force of the molding surface (2a, 20a, 30a, 31a, 32a, and 40a) of the slide cavity piece (2, 20, 30, 31, 32, and 40) with the molten resin 3 is set to be larger than a friction force between a sliding surface (2b, 20b, 30b, 31b, 32b, and 40b) of the slide cavity piece (2, 20, 30, 31, 32, and 40) and the metallic mold of the mold assembly 1 by a predetermined contact-force increasing method and a friction force decreasing method. By doing so, the slide cavity piece tends to slide in response to the contraction of the molten resin 3, and thereby a highly accurate plastic molded object without a sink can be produced.

Specifically, the molding surface (2a, 20a, 30a, 31a, 32a, and 40a) of the slide cavity piece (2, 20, 30, 31, 32, and 40) may be subjected to a surface treatment to have a high contact-force with the molten resin 3. For example, minute concave and convex portions may be formed on the molding surface (2a, 20a, 30a, 31a, 32a, and 40a) of the slide cavity piece (2, 20, 30, 31, 32, and 40) by a sandblast surface treatment. Alternatively, the molding surface (2a, 20a, 30a, 31a, 32a, and 40a) of the slide cavity piece (2, 20, 30, 31, 32, and 40) may be subjected to a ceramic coating treatment, such as, for example, a TiN coating treatment. With such a surface treatment, the contact-force of the molding surface of the slide cavity piece with the molten resin 3 becomes larger than the friction force between the sliding surface of the slide cavity piece and the metallic mold of the mold assembly 1. As a result, the slide cavity piece tends to slide in response to the contraction of the molten resin 3, and thereby a highly accurate plastic molded object without a sink can be produced.

Further, the slide cavity piece (2, 20, 30, 31, 32, and 40) maybe formed from a porous member, such as, for example, a stainless steel sintered member sold under the trademark KuporeX made by KUBOTA Corporation. With such a porous member, the contact-force of the molding surface of the slide cavity piece with the molten resin 3 becomes larger than the friction force between the sliding surface of the slide cavity piece and the metallic mold of the mold assembly 1. As a result, the slide cavity piece tends to slide in response to the contraction of the molten resin 3, and thereby a highly accurate plastic molded object without a sink can be produced.

Moreover, minute concave portions may be formed on the sliding surface (2b, 20b, 20 30b, 31b, 32b, and 40b) of the slide cavity piece (2, 20, 30, 31, 32, and 40) by a sandblast surface treatment. With such minute concave portions, the contact-force of the molding surface of the slide cavity piece with the molten resin 3 becomes larger than the friction force between the sliding surface of the slide cavity piece and the metallic mold of the mold assembly 1. As a result, the slide cavity piece tends to slide in response to the contraction of the molten resin 3, and thereby a highly accurate plastic molded object without a sink can be produced.

Further, the sliding surface (2b, 20b, 30b, 31b, 32b, and 40b) of the slide cavity piece (2, 20, 30, 31, 32, and 40) may be subjected to a surface treatment, such as, for example, a s DLC coating treatment, and a TiCN ceramic coating treatment, to have a low friction force against the metallic mold of the mold assembly 1. With such a surface treatment, the contact-force of the molding surface of the slide cavity piece with the molten resin 3 becomes larger than the friction force between the sliding surface of the slide cavity piece and the metallic mold of the mold assembly 1. As a result, the slide cavity piece tends to slide in response to the contraction of the molten resin 3, and thereby a highly accurate plastic molded object without a sink can be produced.

FIG. 12 is a schematic view of an optical plastic lens as an example of a plastic molded object. When an optical plastic lens 60 illustrated in FIG. 12 is produced by the above-described method with the mold assembly 1, the shape accuracy of the optical plastic lens 60 is enhanced. Further, the high quality optical plastic lens 60 can be produced while restraining an internal distortion therein. If the optical plastic lens 60 having a high accuracy in its shape is used in an optical system of, for example, a laser printer, a high performance of optical characteristics can be obtained while eliminating defects, such as deviation of a focusing position, and increase of a diameter of a beam spot. As a result, a high quality image can be obtained.

As described above, in the mold assembly 1 according to the embodiments of the present invention, during a period when the molten resin 3 filled in the cavity (B) cools to a temperature lower than a softening temperature of the resin 3, the volume of the molten resin 3 in the cavity (B) contracts and the slide cavity piece (2, 20, 30, 31, 32, and 40) slides toward the molten resin 3 in the cavity (13) by a contact-force of the molding surface (2a, 20a, 30a, 31a, 32a, and 40a) of the slide cavity piece (2, 20, 30, 31, 32, and 40) with the molten resin 3 to compensate for contraction of the volume of the molten resin 3. Thus, even if a plastic molded object has uneven thickness portions, a highly accurate plastic molded object without a sink can be produced.

Numerous additional modifications and variations of the present invention are possible in light of the above teachings. It is therefore understood that within the scope of the appended claims, the present invention may be practiced other than as specifically described herein.

What is claimed:

1. A method of producing a plastic molded object, comprising the steps of:
preparing a mold assembly including at least one transfer surface of a cavity, at least one slide cavity piece including at least one sliding surface and at least one molding surface that forms at least a part of at least one surface of the plastic molded object, and at least one metallic mold that slidably holds the at least one slide cavity piece;
heating the mold assembly to a temperature lower than a softening temperature of a molten resin;
filling the cavity with the molten resin heated to at least the softening temperature of the molten resin by injecting the molten resin in the cavity;
generating a pressure on the at least one transfer surface of the cavity, thereby bringing the molten resin into intimate contact with the at least one transfer surface of the cavity to form at least one surface of the plastic molded object;
cooling the molten resin to a temperature lower than the softening temperature of the molten resin;
during the cooling, sliding the at least one slide cavity piece toward the molten resin in the cavity by a contact-force of the at least one molding surface of the at least one slide cavity piece with the molten resin, thereby compensating for contraction of the volume of the molten resin; and
taking the plastic molded object from the mold assembly.

2. The method according to claim 1, further comprising the step of: providing that the contact-force of the at least one molding surface of the at least one slide cavity piece with the molten resin exceeds a friction force between the at least one sliding surface of the at least one slide cavity piece and the at least one metallic mold.

3. The method according to claim 1, further comprising the step of: forming the at least one slide cavity piece from a porous member.

4. The method according to claim 1, further comprising the step of: subjecting the at least one molding surface of the at least one slide cavity piece to a surface treatment to have a high contact-force with the molten resin.

5. The method according to claim 4, wherein the step of subjecting comprises forming minute concave and convex portions on the at least one molding surface of the at least one slide cavity piece by a sandblast surface treatment.

6. The method according to claim 4, wherein the step of subjecting comprising providing a coating treatment on the at least one molding surface of the at least one slide cavity piece.

7. The method according to claim 1, further comprising the step of: providing minute concave portions on the at least one sliding surface of the at least one slide cavity piece to reduce the friction force between the at least one sliding surface of the at least one slide cavity piece and the at least one metallic mold.

8. The method according to claim 1, further comprising the step of: subjecting the at least one sliding surface of the at least one slide cavity piece to a surface treatment to have a low friction force against the at least one metallic mold.

9. The method according to claim 8, wherein the step of subjecting comprises providing a coating treatment on the at least one sliding surface of the at least one slide cavity piece.

10. The method according to claim 1, further comprising the step of: forming with the at least one molding surface of the at least one slide cavity piece at least a part of at least one surface of the plastic molded object other than the at least one surface of the plastic molded object formed with the at least one transfer surface of the cavity.

11. The method according to claim 1, further comprising the step of: forming with at least two molding surfaces of the at least one slide cavity piece at least a part of one side surface of the plastic molded object other than the at least one surface of the plastic molded object formed with the at least one transfer surface of the cavity.

12. The method according to claim 1, further comprising the step of: forming with the at least one molding surface of the at least one slide cavity piece at least a part of at least one surface of a thick portion of the plastic molded object other than the at least one surface of the plastic molded object formed with the at least one transfer surface of the cavity.

13. The method according to claim 1, comprising the step of: forming the at least one molding surface of the at least one slide cavity piece as at least part of the at least one transfer surface of the cavity.

14. A mold assembly for producing a plastic molded object out of a resin, comprising:
said mold assembly defining a cavity configured to be filled with a molten resin heated to a temperature equal to at least a softening temperature of the resin and at least one transfer surface of the cavity forming at least one surface of the plastic molded object;
at least one slide cavity piece including at least one sliding surface and at least one molding surface that forms at least a part of at least one surface of the plastic molded object; and
at least one metallic mold configured to slidably bold the at least one slide cavity piece,
wherein, during a period when the molten resin in the cavity cools to a temperature lower than a softening temperature of the resin, a volume of the molten resin in the cavity contracts and the at least one slide cavity piece slides toward the molten resin in the cavity by a contact-force of the at least one molding surface of the at least one slide cavity piece with the molten resin to compensate for contraction of the volume of the molten resin.

15. The mold assembly according to claim 14, wherein the contact-force of the at least one molding surface of the at least one slide cavity piece with the molten resin is larger than a friction force between the at least one sliding surface of the at least one slide cavity piece and the at least one metallic mold.

16. The mold assembly according to claim 14, wherein the at least one slide cavity piece is formed from a porous member.

17. The mold assembly according to claim 14, comprising a surface treatment on the at least one molding surface of the at least one slide cavity piece that provides a high contact-force with the molten resin.

18. The mold assembly according to claim 17, wherein said surface treatment comprises minute concave and convex portions formed on the at least one molding surface of the at least one slide cavity piece by a sandblast surface treatment.

19. The mold assembly according to claim 17, wherein the surface treatment comprises a coating treatment on the at least one molding surface of the at least one slide cavity piece.

20. The mold assembly according to claim 14, comprising minute concave portions formed on the at least one sliding surface of the at least one slide cavity piece to reduce the friction force between the at least one sliding surface of the at least one slide cavity piece and the at least one metallic mold.

21. The mold assembly according to claim 14, comprising a surface treatment on the at least one sliding surface of the at least one slide cavity piece to provide a low friction force against the at least one metallic mold.

22. The mold assembly according to claim 21, wherein the surface treatment comprises a coating treatment on the at least one sliding surface of the at least one slide cavity piece.

23. The mold assembly according to claim 14, wherein the at least one molding surface of the at least one slide cavity piece forms at least a part of at least one surface of the plastic molded object other than the at least one surface of the plastic molded object formed with the at least one transfer surface of the cavity.

24. The mold assembly according to claim 14, wherein the at least one slide cavity piece comprises at lest two molding surfaces and the at least two molding surfaces of the at least one slide cavity piece form at least a part of one side surface of the plastic molded object other than the at least one surface of the plastic molded object formed with the at least one transfer surface of the cavity.

25. The mold assembly according to claim 14, wherein the at least one molding surface of the at least one slide cavity piece forms at least a part of at least one surface of a thick portion of the plastic molded object other than the at least one surface of the plastic molded object formed with the at least one transfer surface of the cavity.

26. The mold assembly according to claim 14, wherein the at least one molding surface of the at least one slide cavity piece includes the at least one transfer surface of the cavity.

27. The mold assembly according to claim 14, wherein the at least one slide cavity piece is interchangeable with another slide cavity piece having a different-shaped molding surface from a shape of the at least one molding surface of the at least one slide cavity piece according to an area of the plastic molded object where a sink tends to occur.
